(19) United States
(12) Patent Application Publication
(10) Pub. No.: US 2025/0131225 A1
(43) Pub. Date: Apr. 24, 2025

(54) GENERATING METHOD, READING METHOD, AND USING METHOD FOR ONE-CODE MULTI-CONTENT TWO-DIMENSIONAL CODE, AND TERMINAL

(71) Applicant: HANGZHOU LAIBU TECHNOLOGY CO., LTD, Hangzhou (CN)

(72) Inventors: Xiaojun Zhu, Hangzhou (CN); Yanhua Li, Hangzhou (CN); Fengchun Yang, Hangzhou (CN); Zhixiao Yang, Hangzhou (CN)

(21) Appl. No.: 18/925,146

(22) Filed: Oct. 24, 2024

(30) Foreign Application Priority Data
Oct. 24, 2023 (CN) 202311383030.0

(51) Int. Cl. G06K 19/06

(52) U.S. Cl. CPC G06K 19/06037

(57) ABSTRACT

The invention relates to a generating method, a reading method, and a using method of one-code multi-content two-dimensional code, and a terminal. The method comprises: obtaining first data information and second data information; Converting the first data information into a black-and-white two-dimensional code according to a first conversion algorithm; Coloring the black portion of the black-and-white two-dimensional code according to the second conversion algorithm and the second data information, and the generated color two-dimensional code contains the first data information and the second data information. In the code scanning process, after obtaining the color two-dimensional code, the first data information is obtained by using a first decoding method, and the first data information and the second data information are obtained by using a second decoding method. The invention not only increases the data capacity of the two-dimensional code, but also can obtain different data by using different code scanning modes.

### CROSS REFERENCE TO RELATED APPLICATIONS

The present application claims the benefit of Chinese Patent Application No. 202311383030.0 filed on Oct. 24, 2023, the contents of which are incorporated herein by reference in their entirety.

### TECHNICAL FIELD

The present invention relates to the field of two-dimensional codes, and more particularly to a generating method, a reading method, a using method for a one-code multi-content two-dimensional code, and a terminal.

### DESCRIPTION OF RELATED ART

Two-dimensional codes have been widely used in modern life, but based on the principle of existing two-dimensional codes, their data capacity is limited, usually within 500 Chinese characters or 1850 characters, so the existing two-dimensional codes have limited expression content, usually payment information or webpage links, etc. Therefore, how to expand the capacity of two-dimensional code to display more information is a problem that needs to be solved.

In addition, the existing two-dimensional code usually only corresponds to one decoding method, and after mastering the decoding method, all information represented by the two-dimensional code can be obtained, and authority management of different information in the two-dimensional code cannot be realized.

### BRIEF SUMMARY OF THE INVENTION

A technical problem to be solved by the present invention is to provide a generating method, a reading method, a using method for a one-code multi-content two-dimensional code, and a terminal.

The technical scheme adopted by the invention to solve the technical problem is that a generating method for a one-code multi-content two-dimensional code is provided, which comprises the following steps:
Obtaining first data information and second data information;
Converting the first data information into a black-and-white two-dimensional code according to a first conversion algorithm;
Coloring the black portion of the black-and-white two-dimensional code according to a second conversion algorithm and the second data information, and the generated color two-dimensional code contains the first data information and the second data information.

Further, in the generating method for a one-code multi-content two-dimensional code according to the present invention, the step of coloring the black portion of the black-and-white two-dimensional code according to the second conversion algorithm and the second data information comprises:

The second conversion algorithm converts the second data information into color information according to the black color patch distribution of the black-and-white two-dimensional code, and uses the color information to color the black portion of the black-and-white two-dimensional code.

Further, in the generating method for a one-code multi-content two-dimensional code according to the present invention, the color information comprises at least two colors, and each color corresponds to a preset coding information.

In addition, the present invention also provides reading method for a one-code multi-content two-dimensional code, comprising:
Obtaining a color two-dimensional code, the color two-dimensional code containing first data information and second data information;
Analyzing contrast color information of the color two-dimensional code;
Decoding the contrast color information using a first decoding algorithm to obtain first data information.

In addition, the present invention also provides a reading method for a one-code multi-content two-dimensional code, comprising:
Obtaining a color two-dimensional code;
Obtaining color information of the color two-dimensional code;
Decoding the color information using a second decoding algorithm to obtain first data information and second data information.

Further, in the reading method for a one-code multi-content two-dimensional code according to the present invention, the step of obtaining the first data information and the second data information by decoding the color information using the second decoding algorithm comprising:

The second decoding algorithm decodes the color information according to the correspondence relationship between the color and the preset encoding information to obtain the first data information and the second data information, and each color corresponds to a preset encoding information.

In addition, the present invention also provides a using method for a one-code multi-content two-dimensional code, comprising:
Obtaining first data information and second data information;
Converting the first data information into a black-and-white two-dimensional code according to a first conversion algorithm;
Coloring the black portion of the black-and-white two-dimensional code according to a second conversion algorithm and the second data information, the generated color two-dimensional code containing the first data information and the second data information;
Obtaining the color two-dimensional code and decoding the color two-dimensional code using a first decoding method or a second decoding method;
The first decoding method comprises: analyzing contrast color information of the color two-dimensional code, and decoding the contrast color information using a first decoding algorithm to obtain first data information;
The second decoding method comprises: obtaining color information of the color two-dimensional code, and decoding the color information using a second decoding algorithm to obtain first data information and second data information.

Further, in the using method for a one-code multi-content two-dimensional code according to the present invention, the step of coloring the black portion of the black-and-white two-dimensional code according to a second conversion algorithm and the second data information comprises:
The second conversion algorithm converts the second data information into color information according to the black color block distribution of the black-and-white two-dimensional code, and uses the color information to color the black portion of the black-and-white two-dimensional code; the color information comprises at least two colors, and each color corresponds to a preset coding information.

Further, in the using method for a one-code multi-content two-dimensional code according to the present invention, the step of decoding the color information using a second decoding algorithm to obtain the first data information and the second data information comprises:

The second decoding algorithm decodes the color information according to the correspondence relationship between the color and the preset encoding information to obtain first data information and second data information, and each color corresponds to a preset encoding information.

In addition, the present invention also provides an intelligent terminal with a code scanning module, a memory, and a processor;

The code scanning module is configured to obtain a color two-dimensional code;

A computer program is stored in the memory, and by calling the computer program stored in the memory, the processor executes the steps of the generating method for a one-code multi-content two-dimensional code as described above; Or executes the steps of the reading method for a one-code multi-content two-dimensional code as described above; Or executes the steps of using method for a the one-code multi-content two-dimensional code as described above.

A generating method, a reading method, a using method for a one-code multi-content two-dimensional code, and a terminal according to the present invention have the following beneficial effects: the invention not only increases the data capacity of the two-dimensional code by using the color two-dimensional code, but also can obtain different data by using different code scanning methods for the color two-dimensional code, and realizes authority management of the two-dimensional code data.

### BRIEF DESCRIPTION OF THE SEVERAL VIEWS OF THE DRAWINGS

The present invention will be further described below with reference to the accompanying drawings and examples, in which:

FIG. 1 is a flowchart of a generating method for a one-code multi-content two-dimensional code according to an embodiment of the present invention.

FIG. 2 is a flowchart of a reading method for a one-code multi-content two-dimensional code according to an embodiment of the present invention;

FIG. 3 is a flowchart of a reading method for a one-code multi-content two-dimensional code according to an embodiment of the present invention.

FIG. 4 is a flowchart of a using method for a one-code multi-content two-dimensional code according to an embodiment of the present invention.

### DETAILED DESCRIPTION OF THE INVENTION

In order to have a clearer understanding of the technical features, objects and effects of the present invention, specific embodiments of the present invention will now be described in detail with reference to the accompanying drawings.

The two-dimensional code is a black-and-white figure distributed in a plane (two-dimensional direction) with a specific geometric figure according to a certain law, and records data symbol information. In coding, the concepts of “0” and “1” bit streams that form the internal logic basis of the computer are skillfully utilized, and several geometric shapes corresponding to binary are used to represent character numerical information, which is automatically read by image input equipment or photoelectric scanning equipment to realize automatic information processing. It has some commonalities of barcode technology: each code system has its own specific character set, each character occupies a certain width, has a certain verification function, etc. At the same time, it also has the function of automatic identification of different lines of information and processing the rotation change points of graphics. The two-dimensional code capacity refers to the maximum amount of data that a two-dimensional code can store.

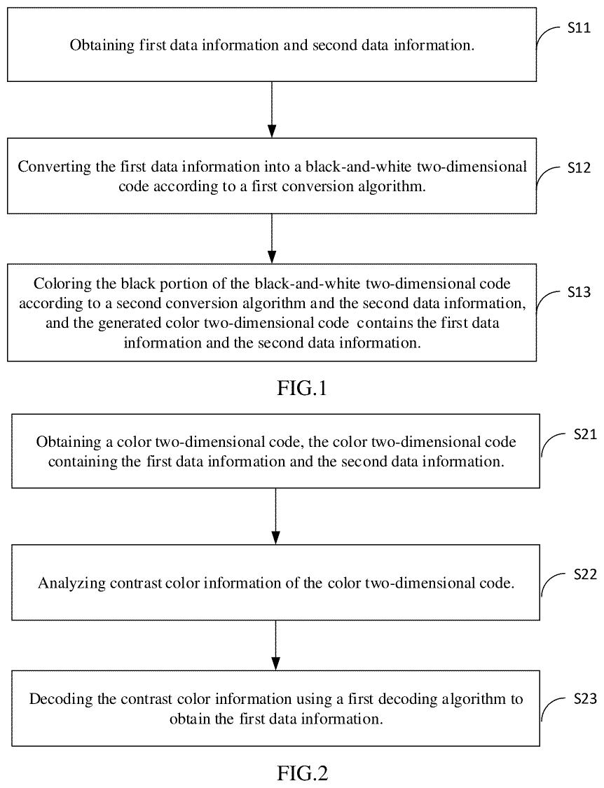

In a preferred embodiment, referring to FIG. 1, the generating method for a one-code multi-content two-dimensional code of the present embodiment comprises the following steps:

Step S11: obtaining first data information and second data information.

Specifically, the first data information and the second data information belong to different information, and in this embodiment, the first data information and the second data information need to be displayed in the form of a two-dimensional code, and the first data information and the second data information need to be contained in the same two-dimensional code at the same time, and the first data information and the second data information need to be contained in different dimensions of the two-dimensional code.

Step S12: converting the first data information into a black-and-white two-dimensional code according to a first conversion algorithm.

Specifically, the first conversion algorithm is an algorithm that converts data information into a two-dimensional code, and there are many first conversion algorithms in the prior art, and the prior art can be referred to. In this embodiment, the first data information is converted into a black-and-white two-dimensional code according to a first conversion algorithm, and the black-and-white two-dimensional code is composed only of black and white, wherein the black portion represents the first data information, that is, the first data information can be obtained by reading and decoding the black portion in the black-and-white two-dimensional code.

Step S13: coloring the black portion of the black-and-white two-dimensional code according to a second conversion algorithm and the second data information, and the generated color two-dimensional code contains the first data information and the second data information.

Specifically, after the first data information is converted into a black-and-white two-dimensional code, the black-and-white two-dimensional code contains the first data information, and it is further necessary to fuse the second data information into the black-and-white two-dimensional code. The present embodiment provides a second conversion algorithm for coloring the black portion of the black-and-white two-dimensional code, and the coloring refers to coloring part or all of the black portion of the black-and-white two-dimensional code into color.

Further, when coloring the black portion of the black-and-white two-dimensional code, the second conversion algorithm converts the second data information into color information according to the black color patch distribution of the black-and-white two-dimensional code, and uses the color information to color the black portion of the black-and-white two-dimensional code. The color information comprises at least two kinds of colors, and each color corresponds to a preset coded information. For example, in a black-and-white two-dimensional code, white represents 0 and black represents 1; The color information comprises red, orange, yellow, green, cyan, blue and purple, and the preset coding information corresponding to red, orange, yellow, green, cyan, blue and purple is 2, 3, 4, 5, 6, 7 and 8 respectively. It will be understood that the more colors used in the color information, the greater the data capacity that the color two-dimensional code can contain.

It can be seen that when the second conversion algorithm is used to color the black-and-white two-dimensional code in this embodiment, only the black portion of the black-and-white two-dimensional code is colored, and thus the black two-dimensional code data is not destroyed, that is, the first data information contained in the black two-dimensional code is not destroyed. Further, by coloring the black-and-white two-dimensional code, the second data information is displayed by color without destroying the black two-dimensional code, so that the first data information and the second data information are displayed in the same two-dimensional code.

In this embodiment, on the basis of the black-and-white two-dimensional code, the color representative coding information is further used, so that the color two-dimensional code can further increase the data capacity on the basis of the original black-and-white two-dimensional code, and the same two-dimensional code can contain two kinds of information in different dimensions, thereby improving information security.

In a preferred embodiment, referring to FIG. 2, the two-dimensional code read by the reading method for a one-code multi-content two-dimensional code of the present embodiment is a color two-dimensional code generated by the generating method for a one-code multi-content two-dimensional code in the above-described embodiment. Specifically, the reading method for a one-code multi-content two-dimensional code comprises the following steps:

Step S21: obtaining a color two-dimensional code, the color two-dimensional code containing the first data information and the second data information.

Specifically, when the intelligent terminal obtains the color two-dimensional code, the color two-dimensional code may be obtained by the camera of an intelligent terminal, or the color two-dimensional code may be received by the communication unit of an intelligent terminal. The color two-dimensional code contains the first data information and the second data information, and it can be understood that the color two-dimensional code is not displayed in color in a two-dimensional code in the prior art.

Step S22: analyzing contrast color information of the color two-dimensional code.

Specifically, in the present embodiment, since it is necessary to read the first data information contained in the color two-dimensional code, and the first data information is contained in the black-and-white two-dimensional code, it is necessary to analyze the contrast color information of the color two-dimensional code when the first data information is obtained. The contrast color information refers to the contrast information between the colored area and the white area in the color two-dimensional code, that is, the information represented by the colored area in the color two-dimensional code is 1, and the information represented by the white area is 0. It can be understood that at this time, it does not care what color the color area is, but only whether the area is colored or white, so the contrast color information of the color two-dimensional code is essentially the same as the contrast information of the black-and-white two-dimensional code.

Step S23: decoding the contrast color information using a first decoding algorithm to obtain the first data information.

Specifically, corresponding to the color two-dimensional code generated by the generating method for a one-code multi-content two-dimensional code of the above-described embodiment, the first decoding algorithm of the present embodiment corresponds to the first conversion algorithm, that is, the first decoding algorithm is an inverse process of the first conversion algorithm, wherein the first conversion algorithm is used for converting the first data information into a black-and-white two-dimensional code, The first decoding algorithm is used for decoding the contrast color information (equivalent to the black and white two-dimensional code) to obtain the first data information.

In the present embodiment, when reading the first data information in the color two-dimensional code, it is necessary to first obtain the contrast color information of the color two-dimensional code, and then obtain the first data information from the contrast color information. Further, it may be described that the present embodiment can individually read part of the information in the two-dimensional code, thereby ensuring the security of other information in the two-dimensional code.

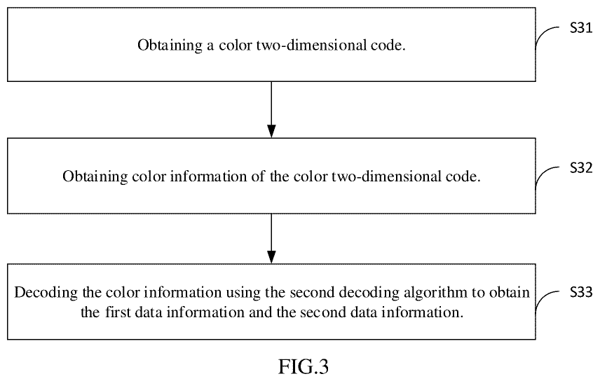

In a preferred embodiment, referring to FIG. 3, the two-dimensional code read by the reading method for a one-code multi-content two-dimensional code of the present embodiment is a color two-dimensional code generated by the generating method for a one-code multi-content two-dimensional code in the above-described embodiment. Specifically, the one-code multi-content two-dimensional code reading method comprises the following steps:

Step S31: obtaining a color two-dimensional code.

Specifically, when the intelligent terminal obtains the color two-dimensional code, the color two-dimensional code may be obtained by the camera of the intelligent terminal, or the color two-dimensional code may be received by the communication unit of the intelligent terminal. The color two-dimensional code contains the first data information and the second data information, and it can be understood that the color two-dimensional code is not displayed in color in a two-dimensional code in the prior art.

Step S32: obtaining color information of the color two-dimensional code.

Specifically, in the present embodiment, it is necessary to read the first data information and the second data information contained in the color two-dimensional code, and the first information in the color two-dimensional code is contained in the black-and-white two-dimensional code, and the second data information is contained in the color portion, so it is necessary to obtain the color information of the color two-dimensional code. The color information comprises color information and position information of a position where the color information is located.

Step S33: decoding the color information using the second decoding algorithm to obtain the first data information and the second data information.

Specifically, when the color information is decoded using the second decoding algorithm to obtain the first data information and the second data information, the second decoding algorithm decodes the color information according to the correspondence relationship between the color and the preset encoding information to obtain the first data information and the second data information, and each color corresponds to a preset encoding information. Further, the second decoding algorithm obtains the first data information and the second data information according to the color information and the position information of the position where the color information is located.

Alternatively, after obtaining the color information, the second data information may be decoded using the color information first, and then the color two-dimensional code may be converted into 0 a black-and-white two-dimensional code, and the black-and-white two-dimensional code may be decoded using the first decoding algorithm to obtain the first data information, and finally the first data information and the second data information may be obtained.

In this embodiment, the first data information and the second data information can be simultaneously decoded by using the second decoding algorithm. Compared with the prior art two-dimensional code, which can only decode one type of data, the present embodiment can realize authority management of different data and improve data security.

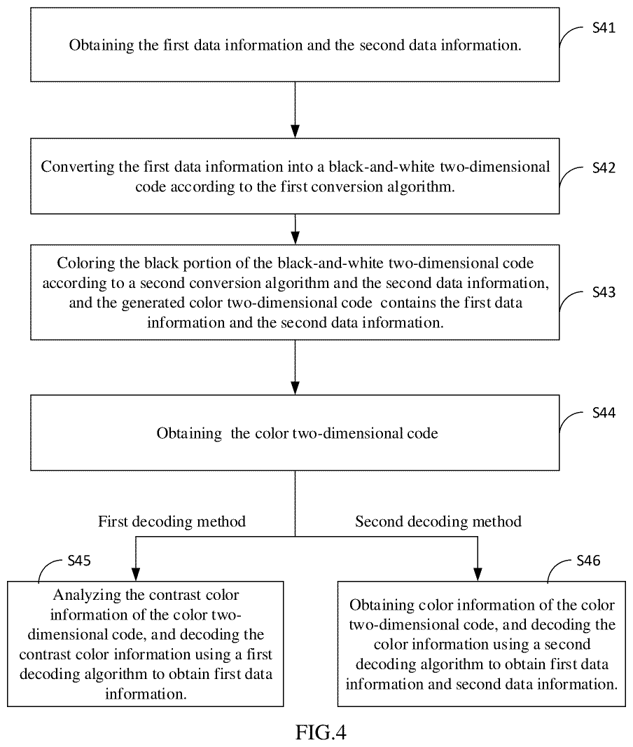

In a preferred embodiment, referring to FIG. 4, the using method for a one-code multi-content two-dimensional code of the present embodiment comprises the following steps:

Step S41: obtaining the first data information and the second data information.

Specifically, the first data information and the second data information belong to different information, and in this embodiment, the first data information and the second data information need to be displayed in the form of a two-dimensional code, and the first data information and the second data information need to be contained in the same two-dimensional code at the same time, and the first data information and the second data information need to be contained in different dimensions of the two-dimensional code.

Step S42: converting the first data information into a black-and-white two-dimensional code according to the first conversion algorithm.

Specifically, the first conversion algorithm is an algorithm that converts data information into a two-dimensional code, and there are many first conversion algorithms in the prior art, and the prior art can be referred to. In this embodiment, the first data information is converted into a black-and-white two-dimensional code according to a first conversion algorithm, and the black-and-white two-dimensional code is composed only of black and white, wherein the black portion represents the first data information, that is, the first data information can be obtained by reading and decoding the black portion in the black-and-white two-dimensional code.

Step S43: coloring the black portion of the black-and-white two-dimensional code according to a second conversion algorithm and the second data information, and the generated color two-dimensional code contains the first data information and the second data information.

Specifically, after the first data information is converted into a black-and-white two-dimensional code, the black-and-white two-dimensional code contains the first data information, and it is further necessary to fuse the second data information into the black-and-white two-dimensional code. The present embodiment provides a second conversion algorithm for coloring the black portion of the black-and-white two-dimensional code and the coloring refers to coloring part or all of the black portion of the black-and-white two-dimensional code into color.

Further, when the black portion of the black-and-white two-dimensional code is colored, the second conversion algorithm converts the second data information into color information according to the black color patch distribution of the black-and-white two-dimensional code, and uses the color information to color the black portion of the black-and-white two-dimensional code. It should be noted that the color information comprises at least two kinds of colors, and each color corresponds to one kind of preset coded information. For example, in a black-and-white two-dimensional code, white represents 0 and black represents 1; The color information comprises red, orange, yellow, green, cyan, blue and purple, and the preset coding information corresponding to red, orange, yellow, green, cyan, blue and purple is 2, 3, 4, 5, 6, 7 and 8 respectively. It will be understood that the more colors used in the color information, the greater the data capacity that the color two-dimensional code can contain.

It can be seen that when the second conversion algorithm is used to color the black-and-white two-dimensional code in this embodiment, only the black portion of the black-and-white two-dimensional code is colored, and thus the black two-dimensional code data is not destroyed, that is, the first data information contained in the black two-dimensional code is not destroyed. Further, by coloring the black-and-white two-dimensional code, the second data information is displayed by color without destroying the black two-dimensional code, so that the first data information and the second data information are displayed in the same two-dimensional code.

Step S44: obtaining the color two-dimensional code and decoding the color two-dimensional code using the first decoding method or the second decoding method.

Specifically, when an intelligent terminal obtained the color two-dimensional code, the color two-dimensional code may be obtained by the camera of the intelligent terminal, or the color two-dimensional code may be received by the communication unit of the intelligent terminal. The color two-dimensional code contains the first data information and the second data information, and it can be understood that the color two-dimensional code is not displayed in color in a two-dimensional code in the prior art.

Step S45: The first decoding method comprises: analyzing the contrast color information of the color two-dimensional code, and decoding the contrast color information using a first decoding algorithm to obtain first data information.

Specifically, in the present embodiment, since it is necessary to read the first data information contained in the color two-dimensional code, and the first data information is contained in the black-and-white two-dimensional code, it is necessary to analyze the contrast color information of the color two-dimensional code when it is thought to obtain the first data information. The contrast color information refers to the contrast information between the colored area and the white area in the color two-dimensional code, that is, the information represented by the colored area in the color two-dimensional code is 1, and the information represented by the white area is 0. It can be understood that at this time, it does not care what color the color area is, but only whether the area is colored or white, so the contrast color information of the color two-dimensional code is essentially the same as the contrast information of the black-and-white two-dimensional code. Further, corresponding to the color two-dimensional code generated by the generating method for a one-code multi-content two-dimensional code of the above embodiment, the first decoding algorithm of the present embodiment corresponds to the first conversion algorithm, that is, the first decoding algorithm is an inverse process of the first conversion algorithm, wherein the first conversion algorithm is used to convert the first data information into a black-and-white two-dimensional code, The first decoding algorithm is used for decoding the contrast color information (equivalent to the black and white two-dimensional code) to obtain the first data information.

Step S46: The second decoding method comprises: obtaining color information of the color two-dimensional code, and decoding the color information using a second decoding algorithm to obtain first data information and second data information.

Specifically, in the present embodiment, it is necessary to read the first data information and the second data information contained in the color two-dimensional code, and the first information in the color two-dimensional code is contained in the black-and-white two-dimensional code, and the second data information is contained in the color portion, so it is necessary to obtain the color information of the color two-dimensional code. The color information comprises color information and position information of a position where the color information is located. Further, the second decoding algorithm decodes the color information according to the correspondence relationship between the color and the preset encoding information to obtain the first data information and the second data information, and each color corresponds to a preset encoding information. Further, the second decoding algorithm obtains the first data information and the second data information according to the color information and the position information of the position where the color information is located.

In this embodiment, the use of the color two-dimensional code not only increases the data capacity of the two-dimensional code, but also the color two-dimensional code can obtain different data by using different code scanning methods, so that authority management of the two-dimensional code data is realized and data security is improved.

In a preferred embodiment, the intelligent terminal of the present embodiment with a code scanning module, a memory, and a processor, wherein the code scanning module is used for obtaining a color two-dimensional code, and the code scanning module is a camera or a communication module. Alternatively, the smart terminal may be a smart phone, a smart watch, a platform computer, a notebook computer, a desktop computer, an appliance, a vehicle terminal, or the like.

Further, a computer program is stored in the memory of the intelligent terminal, and the processor performs the steps of the generating method for a one-code multi-content two-dimensional code as in the above-described embodiment by calling the computer program stored in the memory. Or performs the steps of the reading method for a one-code multi-content two-dimensional code according to the above-described embodiment. Or performs the steps of the using method for a one-code multi-content two-dimensional code according to the above embodiment.

In the present specification, each embodiment is described in a progressive manner, and the differences between each embodiment and other embodiments are emphasized, and the same and similar parts between each embodiment can be referred to each other. As for the apparatus disclosed in the embodiment, since the apparatus corresponds to the method disclosed in the embodiment, the description is relatively simple, and the description of the method section can be refer to for related details.

Those skilled in the art may further appreciate that the elements and algorithmic steps of the examples described in connection with the embodiments disclosed herein can be implemented in electronic hardware, computer software, or a combination of both, and in order to clearly illustrate the interchangeability of hardware and software, the components and steps of the examples have been described generally in terms of functionality in the foregoing description. Whether these functions are performed in hardware or software depends on the specific application and design constraints of the technical solution. Those skilled in the art may use different methods for implementing the described functions for each particular application, but such implementations should not be considered beyond the scope of the present invention.

The steps of the methods or algorithms described in connection with the embodiments disclosed herein may be implemented directly in hardware, a processor-executed software module, or a combination of both. The software module may be placed in random access memory (RAM), memory, read-only memory (ROM), electrically programmable ROM, electrically erasable programmable ROM, registers, hard disk, removable magnetic disk, CD-ROM, or any other form of storage medium known in the art.

The above embodiments are merely for illustrating the technical concept and features of the present invention, and are intended to enable those skilled in the art to understand the contents of the present invention and carry out the present invention accordingly, and do not limit the scope of protection of the present invention. All changes and modifications equivalent to the scope of the claims of the present invention should fall within the scope of the claims of the present invention.

What is claimed is:

1. A generating method for a one-code multi-content two-dimensional code, comprising:
obtaining first data information and second data information;
converting the first data information into a black-and-white two-dimensional code according to a first conversion algorithm;
coloring the black portion of the black-and-white two-dimensional code according to a second conversion algorithm and the second data information, and the generated color two-dimensional code contains the first data information and the second data information.

2. The generating method for a one-code multi-content two-dimensional code according to claim 1, wherein coloring the black portion of the black-and-white two-dimensional code according to second conversion algorithm and the second data information comprises:
the second conversion algorithm converts the second data information into color information according to the black color patch distribution of the black-and-white two-dimensional code, and uses the color information to color the black portion of the black-and-white two-dimensional code.

3. The generating method for a one-code multi-content two-dimensional code according to claim 2, wherein the color information comprises at least two colors, and each color corresponds to a preset coding information.

4. A reading method for a one-code multi-content two-dimensional code, applied to the color two-dimensional code generated by the generating method for a one-code multi-content two-dimensional code according to claim 1, the method comprising:
obtaining a color two-dimensional code, the color two-dimensional code containing first data information and second data information;
analyzing contrast color information of the color two-dimensional code;
decoding the contrast color information using a first decoding algorithm to obtain first data information.

5. A reading method for a one-code multi-content two-dimensional code, applied to the color two-dimensional code generated by the generating method for a one-code multi-content two-dimensional code according to claim 1, the method comprising:
obtaining a color two-dimensional code;
obtaining color information of the color two-dimensional code;
decoding the color information using a second decoding algorithm to obtain first data information and second data information.

6. The reading method for a one-code multi-content two-dimensional code according to claim 5, wherein decoding the color information using a second decoding algorithm to obtain the first data information and the second data information comprising:
the second decoding algorithm decodes the color information according to the correspondence relationship between the color and the preset encoding information to obtain the first data information and the second data information, and each color corresponds to a preset encoding information.

7. A using method for a one-code multi-content two-dimensional code, comprising:
obtaining first data information and second data information;
converting the first data information into a black-and-white two-dimensional code according to a first conversion algorithm;
coloring the black portion of the black-and-white two-dimensional code according to a second conversion algorithm and the second data information, the generated color two-dimensional code containing the first data information and the second data information;
obtaining the color two-dimensional code and decoding the color two-dimensional code using a first decoding method or a second decoding method;
the first decoding method comprises: analyzing the contrast color information of the color two-dimensional code, decoding the contrast color information using a first decoding algorithm to obtain first data information;
the second decoding method comprises: obtaining color information of the color two-dimensional code, decoding the color information using a second decoding algorithm to obtain first data information and second data information.

8. The using method of a one-code multi-content two-dimensional code according to claim 7, wherein the coloring the black portion of the black-and-white two-dimensional code according to a second conversion algorithm and the second data information comprises:
the second conversion algorithm converts the second data information into color information according to the black color block distribution of the black-and-white two-dimensional code, and uses the color information to color the black portion of the black-and-white two-dimensional code; the color information comprises at least two colors, and each color corresponds to a preset coding information.

9. The using method for a one-code multi-content two-dimensional code according to claim 7, wherein, the decoding the color information using a second decoding algorithm to obtain first data information and second data information comprises:
the second decoding algorithm decodes the color information according to the correspondence relationship between the color and the preset encoding information to obtain the first data information and the second data information, and each color corresponds to a preset encoding information.

10. An intelligent terminal, comprising a code scanning module, a memory, and a processor;
the code scanning module is configured to obtain a color two-dimensional code;
a computer program is stored in the memory, and by calling the computer program stored in the memory, the processor executes the steps of the generating method for a one-code multi-content two-dimensional code according to claim 1.

11. The intelligent terminal according to claim 10, wherein coloring the black portion of the black-and-white two-dimensional code according to second conversion algorithm and the second data information comprises:
the second conversion algorithm converts the second data information into color information according to the black color patch distribution of the black-and-white two-dimensional code, and uses the color information to color the black portion of the black-and-white two-dimensional code.

12. The intelligent terminal according to claim 11, wherein the color information comprises at least two colors, and each color corresponds to a preset coding information.

13. An intelligent terminal, comprising a code scanning module, a memory, and a processor;
the code scanning module is configured to obtain a color two-dimensional code;
a computer program is stored in the memory, and by calling the computer program stored in the memory, the processor executes the steps of the reading method for a one-code multi-content two-dimensional code according to claim 4.

14. An intelligent terminal, comprising a code scanning module, a memory, and a processor;
the code scanning module is configured to obtain a color two-dimensional code;
a computer program is stored in the memory, and by calling the computer program stored in the memory, the processor executes the steps of the reading method for a one-code multi-content two-dimensional code according to claim 5.

15. The intelligent terminal according to claim 14, wherein decoding the color information using a second decoding algorithm to obtain the first data information and the second data information comprising:
the second decoding algorithm decodes the color information according to the correspondence relationship between the color and the preset encoding information to obtain the first data information and the second data information, and each color corresponds to a preset encoding information.

16. An intelligent terminal, comprising a code scanning module, a memory, and a processor;
the code scanning module is configured to obtain a color two-dimensional code;
a computer program is stored in the memory, and by calling the computer program stored in the memory, the processor executes the steps of the using method for a one-code multi-content two-dimensional code according to claim 7.

17. The intelligent terminal according to claim 16, wherein the coloring the black portion of the black-and-white two-dimensional code according to a second conversion algorithm and the second data information comprises:
the second conversion algorithm converts the second data information into color information according to the black color block distribution of the black-and-white two-dimensional code, and uses the color information to color the black portion of the black-and-white two-dimensional code; the color information comprises at least two colors, and each color corresponds to a preset coding information.

18. The intelligent terminal according to claim 16, wherein, the decoding the color information using a second decoding algorithm to obtain first data information and second data information comprises:
the second decoding algorithm decodes the color information according to the correspondence relationship between the color and the preset encoding information to obtain the first data information and the second data information, and each color corresponds to a preset encoding information.
